(19) United States
(12) Patent Application Publication
(10) Pub. No.: US 2017/0123039 A1
(43) Pub. Date: May 4, 2017

(54) ULTRA WIDEBAND (UWB)-BASED HIGH PRECISION POSITIONING METHOD AND SYSTEM

(71) Applicant: INDUSTRIAL BANK OF KOREA, Seoul (KR)

(72) Inventors: Pilsoon SHIN, Busan (KR); Jongman KWON, Gwangju-si (KR)

(21) Appl. No.: 14/926,421

(22) Filed: Oct. 29, 2015

(51) Int. Cl. G01S 5/00; G01S 5/14; G01S 5/02

(52) U.S. Cl. CPC G01S 5/0045; G01S 5/0284; G01S 5/14

(57) ABSTRACT

An ultra wideband (UWB)-based high precision positioning method and system is provided. According to the method and system, a precise position measurement according to a UWB signal characteristic can be achieved by an interaction between a UWB tag and an access point without a separate server in a real-time positioning system, further, a user terminal can receive information even when a user terminal is not connected to a separate Internet communication network by receiving position information of the UWB tag and additional information based on the position information through Bluetooth or a universal serial bus (USB).

### BACKGROUND

1. Field of the Invention

The present invention relates to a method and system capable of precisely measuring position information of an ultra wideband (UWB) tag without using a separate server for measuring a position.

2. Discussion of Related Art

Generally, a global positioning system (GPS), an inertial navigation system (INS), a long range aid to navigation (LORAN), a radio frequency identification/ubiquitous sensor network (RFID/USN), a method using a wireless communication network, are position confirmation and measurement systems. Among them, “wireless positioning technology” which is the method using the wireless communication network may have a purpose of measuring a precise position of a terminal by a method such as a cell-identification (ID), time of arrival (ToA), time difference of arrival (TDOA), angle of arrival (AoA), a fingerprint, etc. using a code division multiple access (CDMA), an orthogonal frequency division multiplexing (OFDM), a wireless local area network (WLAN), an infrared ray, an ultrasonic wave, Bluetooth, radio frequency identification (RFID), ultra wideband (UWB), etc. in real-time, and technological development of wireless positioning system is being actively performed together with technological concentration of Internet of things (IoT).

In the wireless positioning technology, particularly, a UWB-based positioning method may be a local area high speed data transmission technology which is based on the UWB of institute of electrical and electronics engineers (IEEE) 802.15.3a and is capable of transmitting multimedia data with low power through a wide bandwidth which is equal to or more than 500 MHz, and when compared with technology based on a conventional wireless fidelity (Wi-Fi) and Bluetooth signal, there may be an advantage being able to measure a precise distance in ultrahigh speed and be implemented at low cost while decreasing a power consumption.

Referring to FIG. 1 showing a configuration of a conventional positioning system, the conventional positioning system includes a plurality of access points 10 and tags 20 (for convenience of illustration, only one tag is illustrated) transceiving a UWB signal for measuring a position, and signal information transceived between them is transmitted to a position measurement server 40 through a communication network 100, the position is determined in the server 40, and position information is transmitted to a user terminal or device 30 through the communication network 100.

Accordingly, the positioning system using the UWB signal has an advantage of being capable of measuring a precise distance with low power compared with a positioning system based on other wireless communication networks, but has a limitation in which a separate measurement server (for example, a real-time locating system (RTLS) server, etc.: 40 in FIG. 1) has to be included for calculating position information of the UWB tag from a signal relationship transceived between an object which is a target of position measurement, for example, the UWB tag, and the access point which is a measurement reference for the position measurement by transmitting a UWB signal.

Further, there is a limitation in which a mobile device has to be positioned in an environment having a capacity to transceive a large amount of data at high speed in a state capable of communicating with the access point configuring the UWB positioning system through the communication network 100 such as an Internet or a data communication network for providing the position information and an additional service based on the position information by associating the positioning method using the UWB signal with the mobile device such as a user terminal.

In the technical background, U.S. Pat. No. 8,624,774, which is one among conventional art, documents discloses an object position determination method and system using a UWB signal including one search device configured in a mobile device and one or more target devices attached to a target object, and introduces a method capable of determining a position without synchronizing between two devices by transmitting a time difference with respect to a return signal.

Further, Korean Patent Publication No. 10-2012-0072191, which is another conventional art document, discloses a method, apparatus, and system for tracking a position using a wireless signal such as a UWB signal transceived in a directional antenna, and also discloses a configuration receiving a tracking command with respect to a tracking target transmitting a position tracking signal, driving the antenna, receiving the position tracking signal from the antenna, and measuring a changed position of the tracking target.

However, even according to the conventional documents, in the position determination or tracking method, apparatus, and system using a UWB signal, there is a limitation in which a separate server is included for determining a position of the real target object or the UWB tag from a signal transceiving relation.

An inventor of the present invention recognizes the problems described above, and proposes a method capable of measuring the position more effectively using the UWB signal.

### SUMMARY OF THE INVENTION

The present invention is directed to a precise positioning method and system capable of measuring a position based on a characteristic of an ultra wideband (UWB) signal by an interactive operation between a tag and an access point without a separate server in a real-time positioning system.

According to one aspect of the present invention, there is provided a precise positioning system using UWB including one or more access points configured to transmit a UWB position measurement starting signal every first scheduling period, and a UWB tag configured to measure its own position in response to the UWB position measurement starting signal received from the one or more access points, and further including a user terminal which is paired with the UWB tag, and is configured to receive the measured position from the UWB tag.

The UWB tag may measure the position by a two-way-ranging (TWR) method of calculating a round trip time (RTT), and converting the calculated RTT into a distance to the one or more access points.

Meanwhile, the UWB tag may measure the position by a time difference of arrival (TDOA) method of measuring an arrival time of the UWB position measurement starting signal received from the one or more access points, and in this case, the one or more access points may be synchronized with each other based on the first scheduling period.

Further, in the precise positioning system using the UWB, the user terminal may be paired with the UWB tag by one of a universal serial bus (USB) or Bluetooth.

Moreover, the user terminal may selectively display a position of the UWB tag, a distance between the UWB tag and the user terminal, and service information provided by a manager of the UWB tag, by a preset application program.

According to another aspect of the present invention, there is provided a precise positioning method using UWB including receiving a UWB position measurement starting signal from one or more among a plurality of access points every first scheduling period, measuring a position of a UWB tag in response to the received UWB position measurement starting signal, and transmitting the measured position of the UWB tag to a paired user terminal.

Further, the measuring of the position of the UWB tag may include measuring the position by a TWR method of calculating an RTT to the plurality of access points, and converting the calculated RTT into a distance to the plurality of access points.

Moreover, the precise positioning method using the UWB may further include synchronizing the plurality of access points with each other based on the first scheduling period before the UWB position measurement starting signal is transmitted from one or more access points, and in this case, the measuring of the position of the UWB tag may include measuring the position by a TDOA method of measuring an arrival time of the UWB position measurement starting signal received from the one or more access points.

According to still another aspect of the present invention, there is provided a computer readable storage medium storing a computer program for executing a precise positioning method using UWB. The computer program may include an instruction for receiving a UWB position measurement starting signal from one or more among a plurality of access points every first scheduling period, an instruction for measuring a position of a UWB tag in response to the received UWB position measurement starting signal, and an instruction for transmitting the measured position of the UWB tag to a paired user terminal.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 is a diagram illustrating a configuration of a conventional positioning system;

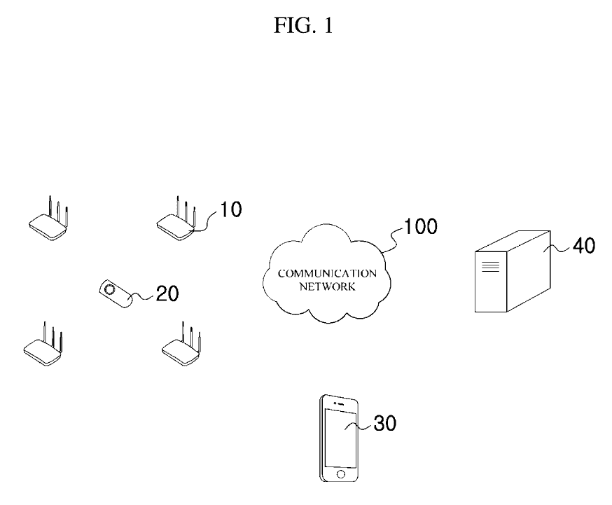

FIG. 2 is a diagram illustrating a configuration of a positioning system according to an embodiment of the present invention;

FIG. 3 is a diagram illustrating a functional configuration of an ultra wideband (UWB) tag in the positioning system according to an embodiment of the present invention;

FIG. 4 is a flowchart for describing a positioning method according to one embodiment of the present invention; and

FIG. 5 is a diagram illustrating a functional configuration of a user terminal configuring a positioning system according to an embodiment of the present invention.

### DETAILED DESCRIPTION OF EXEMPLARY EMBODIMENTS

Hereinafter, exemplary embodiments according to the present invention of a method and system capable of precisely measuring position information of a tag using an ultra wideband (UWB) signal will be described with reference to the accompanying drawings.

It will be further understood that the terms “comprises,” “comprising,” “includes,” and/or “including,” when used herein, specify the presence of stated features, integers, steps, operations, elements, and/or components, but do not preclude one or more other features, integers, steps, operations, elements, components, and/or equivalents thereof. Further, the singular forms “a”, “an,” and “the” are intended to include the plural forms as well, unless the context clearly indicates otherwise. That is, the terms “comprises,” “comprising,” “includes,” and/or “including,” do not preclude the presence or addition of one or more other features, integers, steps, operations, elements, components, and/or groups thereof.

As used herein, the term “access point” may be a fixed station used for communicating with access terminals, refer to a node, an evolved node B (eNodeB), a home enhanced node B (HeNB), or another term, and it should be understood that the access point refers to various objects having a function of communicating with terminals regardless of terms which are referred to on a market such as a random access point, a relay access point, a router access point, etc.

As used herein, the term “terminal” may be an object which is referred to as a technological term such as a mobile station (MS), a mobile terminal (MT), a subscriber station, a portable/mobile subscribed station, a user equipment (UE), an access terminal (AT), etc., and be an electronic communication device for a user including some or all of the MS, the MT, the subscriber station, the UE, the AT, etc.

In a method of measuring a position using a characteristic associated with a wireless frequency, such as a wireless local area network (WLAN), measurement methods such as time of arrival (ToA), time difference of arrival (TDOA), a received signal strength indicator (RSSI), angle of arrival (AoA), etc. which are generally used may be applied. Generally, there may be a distance measurement and a triangulation using attenuation of a wireless signal and a fingerprint method using a pre-constructed radio wave map. A method using the UWB among the positioning methods based on a wireless mobile communication network may be a method designed to transmit a large amount of data with low power in a short distance, and it is well known that the method can perform more precise measurement by a specific frequency compared with another communication method.

A cell identification (ID) method may be an approximation method, and is a method confirming a position of a mobile object by whether a mobile object to be tracked exists in a space which is referred to as a “cell”.

The triangulation method is the most common measurement method, and is a method of measuring a position in which the mobile object actually exists by measuring a distance of a mobile object from three reference positions, and calculates the distance between the mobile object and the reference position using information related to the received signal strength (RSS) received by the mobile object or the reference position, the ToA, the TDOA, carrier signal phase of arrival (POA), the AoA, etc.

Further, all technical terms used herein may be used by selecting general technical terms which are commonly used, but in some cases, may be terms which are arbitrarily selected, and in this case, it should be understood as being interpreted by considering their meanings in the context described in the specification rather than being limited to names of the terms.

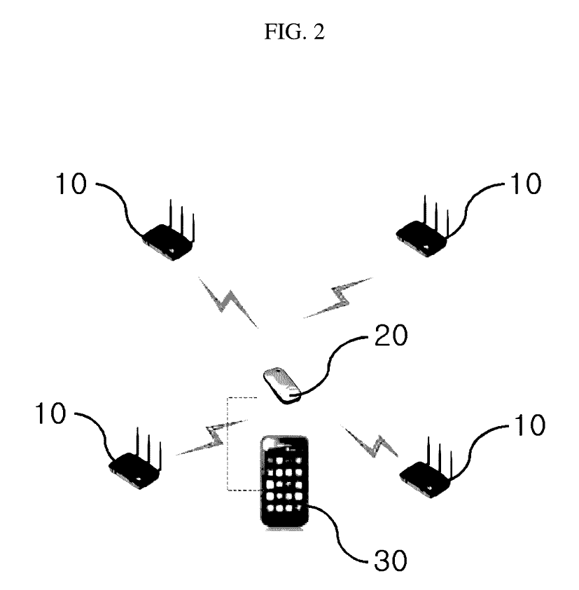

FIG. 2 is a diagram illustrating a configuration of a positioning system according to an embodiment of the present invention, a system according to the present invention may include one or more access points 10 transmitting a UWB position measurement starting signal every first scheduling period, a UWB tag 20 measuring its own position in response to a UWB position measurement starting signal received from the one or more access points 10, and a user terminal 30 paired to the UWB tag 20 with Bluetooth or a universal serial bus (USB), and capable of receiving the measured position of the tag from the UWB tag 20.

That is, in the positioning system according to an embodiment of the present invention, a separate server for measuring a position may not be needed, and the UWB tag 20 may track its own position based on signal transceiving information with the access point 10.

When using the TDOA method for tracking the position, a synchronization may be performed by a wireless synchronization signal between the access points 10, and the UWB tag 20 may collect a signal which the access point 10 periodically transmits and calculate a position of the tag.

Meanwhile, when using the TWR method for tracking the position, the UWB tag 20 may transmit distance information with respect to the access point 10 adjacent to its own, and calculate a relative position of the UWB tag 20 using the distance information. Further, the UWB tag 20 may calculate the relative distance through UWB communication with each access point 10, and calculate its own position based on the relative position.

According to the aspect described above, the position information calculated in the UWB tag 20 may be transmitted to the user terminal 30, and the user terminal 30 may execute an preset application program (for example, an application distributed by a manager or a service provider), and selectively display a position of the UWB tag 20, a distance between the UWB tag 20 and the user terminal 30, information in which a manager or a service provider or an affiliated service providing member of the UWB tag 20 want to provide.

For example, when the system shown in FIG. 2 is constructed in a department store, the access points 10 may be arranged in each predetermined radius or area, and (if desired) a service providing member may arrange the UWB tag 20. A customer possessing the user terminal 30 may enter the department store, the UWB tag 20 may transmit its own position information measured in a relationship with the access points 10 to the user terminal 30, and various additional services the service providing member wants to transmit including product information, event or promotion information may be provided to the customer.

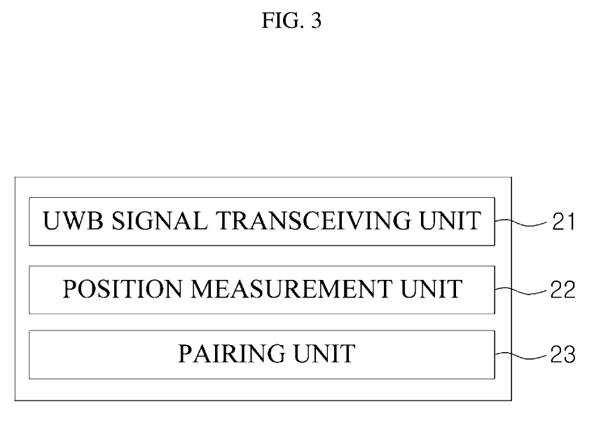

FIG. 3 is a diagram illustrating a functional configuration of a UWB tag in the positioning system according to an embodiment of the present invention. The UWB tag 20 may include a UWB signal transceiving unit 21, a position measurement unit 22, and a pairing unit 23.

The UWB signal transceiving unit 21 may generate a base signal relationship for calculating the position of each UWB tag by transceiving the UWB signal with a plurality of access points.

The position measurement unit 22 may measure the position based on communication information of a signal stored in the UWB signal transceiving unit 21, and measure the position of the tag by the TDOA or TWR method. However, it is only an example, and other methods such as the ToA, RSSI, or AoA method for measuring the position of the UWB tag may be applied.

As one example, when using the TDOA method, the plurality of access points may be synchronized with each other based on a predetermined scheduling period, the UWB tag 20 may measure an arrival time of the UWB position measurement starting signal received from one or more access points, and the position measurement unit 22 may determine the position of the tag. As another example, when using the TWR method, the position measurement unit 22 may calculate a round trip time (RTT), and determine the position of the tag by converting the calculated RTT into a distance to one or more access points.

The pairing unit 23 may connect the UWB tag 20 and the user terminal 30, and include a configuration for implementing a Bluetooth or USB function. Since the UWB tag 20 calculates its own position, does not transmit the position calculated to a separate position measurement server, and transmits the calculated position information to the user terminal 30 through the pairing unit 23, and the user terminal 30 may receive the position information of the UWB tag and the additional information based on the position information by a Bluetooth or USB communication method capable of transceiving data in low power even when the user terminal 30 is not connected to a data communication network such as a third generation (3G), long term evolution (LTE) communication network, or a local area communication network such as wireless fidelity (Wi-Fi).

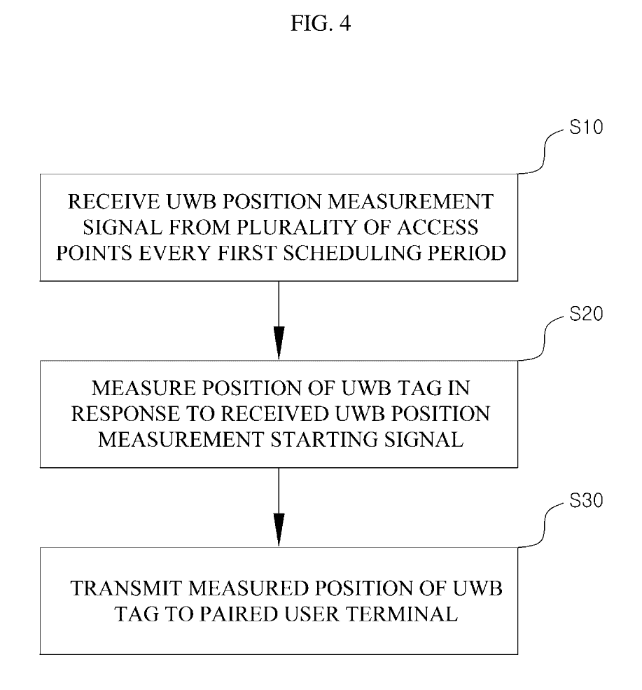

FIG. 4 is a flowchart for describing a positioning method according to one embodiment of the present invention. First, a UWB position measurement signal may be received from a plurality of access points every first scheduling period (operation S10). When a UWB tag is fixed, the first scheduling period may be set to a relatively great period for operating the system, and when the UWB tag is mobile, the first scheduling period may be set to a relatively small period for operating the system.

The position of the UWB tag may be measured in response to the received UWB position measurement starting signal (operation S20). When using the TDOA for measuring the position, the plurality of access points may be synchronized with each other based on the predetermined scheduling period, the UWB tag may measure the arrival time of the UWB position measurement starting signal received from the one or more access points, and the position measurement unit may determine the position of the UWB tag. Further, when using the TWR method for measuring the position, the position measurement unit may calculate the RTT, and determine the position of the UWB tag by converting the calculated RTT into the distance to the one or more access points.

The measured position of the UWB tag may be transmitted to the paired user terminal (operation S30). The user terminal may display the received position information, and also additionally or selectively display the distance between the corresponding tag and the user terminal, and movement area information, and information which the manager of the UWB tag, the service provider, or the affiliated service providing member wants to provide.

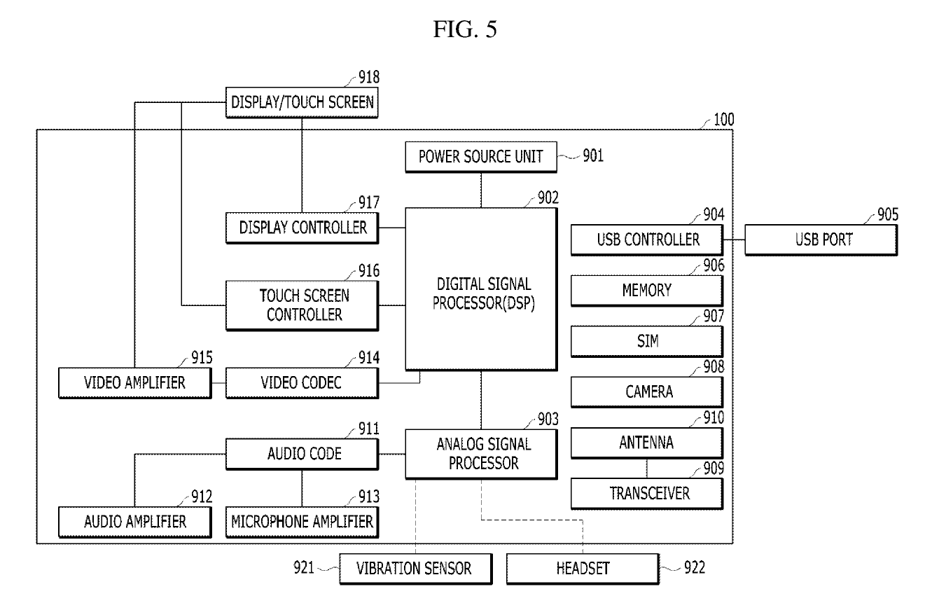

FIG. 5 is a diagram illustrating a functional configuration of a user terminal configuring a positioning system according to an embodiment of the present invention. The user terminal 30 may include a system on chip (SOC) 100 including a digital signal processor (DSP) 902 and an analog signal processor 903 which are connected. The SOC 100 may be connected to a display/touch screen 918, and a USB port 905 outside the SOC 100 by at least some components configuring the SOC 100, and also be connected to a vibration sensor 921, and a headset 922.

Driving power in the SOC 100 may be supplied from a power source unit 901, the DSP 902 may be connected to a USB controller 904, a memory 906, a subscriber identity module (SIM) 907, a camera 908, an audio CODEC 911, a touch screen controller 916, and a display controller 917. Meanwhile, the analog signal processor 903 connected to the DSP 902 may be connected to a transceiver 909 and an audio CODEC 911.

In an embodiment, one or more of operations of the method described above may be stored in the memory 906 as a computer program instruction, and the method described herein may be performed by the DSP 902 which is able to execute the computer program instruction. A connection example of each component described with reference to FIG. 5 is only an example, and when implementing the precise positioning method according to an embodiment of the present invention, at least some of the components may be omitted, on the other hand, when implementing the precise positioning method according to an embodiment of the present invention, not just the components described, but additional components may be further included.

Exemplary modules, logic blocks, means, steps, or a combination thereof related to exemplary embodiments described herein may be implemented by electronic hardware (a digital design designed by a coding, etc.), software (various applications including a program instruction), or a combination thereof. Implementation as any form of the hardware and/or software may be changed according to design limitations imposed on the user terminal.

Further, functions described in this specification may be executed by hardware, software, firmware, or a combination thereof. When being executed by the software, the function may be stored in a computer readable storage medium as one or more instructions or codes, or be transmitted. The computer readable storage medium may be generally referred to as an arbitrary available medium which is accessible by a computer.

According to the present invention, a precise position measurement according to the UWB signal characteristic can be achieved by interaction between the tag and the access point without a separate server in the real-time positioning system.

Further, the information can be provided to the user terminal associated with the precise positioning method according to the present invention even when the user terminal is not connected to a separate Internet communication network by receiving the position information of the UWB tag and the additional information based on the position information through the Bluetooth or the USB.

It may be understood by those of ordinary skill in the art that an effect according to the present invention is not limited to the effects described above.

While the embodiments of the present invention are described in detail above, the scope of the present invention is not limited by the exemplary embodiments of the present invention. The scope of the present invention should be defined by the claims, and it is intended that the present invention covers all such modifications and changes of those of ordinary skill in the art derived from a basic concept of the appended claims, and their equivalents.

What is claimed is:

1. A precise positioning system using ultra wideband (UWB), comprising:
one or more access points configured to transmit a UWB position measurement starting signal every first scheduling period; and
a UWB tag configured to measure its own position in response to the UWB position measurement starting signal received from the one or more access points.

2. The precise positioning system using the UWB of claim 1, further comprising:
a user terminal which is paired with the UWB tag and configured to receive the measured position from the UWB tag.

3. The precise positioning system using the UWB of claim 2, wherein the UWB tag measures the position by a two-way-ranging (TWR) method of calculating a round trip time (RTT), and converting the calculated RTT into a distance to the one or more access points.

4. The precise positioning system using the UWB of claim 2, wherein the one or more access points are synchronized with each other based on the first scheduling period, and
the UWB tag measures the position by a time difference of arrival (TDOA) method of measuring an arrival time of the UWB position measurement starting signal received from the one or more access points.

5. The precise positioning system using the UWB of claim 2, wherein the user terminal is paired with the UWB tag by one of a universal serial bus (USB) or Bluetooth.

6. The precise positioning system using the UWB of claim 5, wherein the user terminal selectively displays a position of the UWB tag, a distance between the UWB tag and the user terminal, and service information provided by a manager of the UWB tag, by a preset application program.

7. A precise positioning method using UWB, comprising:
receiving a UWB position measurement starting signal from one or more among a plurality of access points every first scheduling period;
measuring a position of a UWB tag in response to the received UWB position measurement starting signal; and
transmitting the measured position of the UWB tag to a paired user terminal.

8. The precise positioning method using the UWB of claim 7, wherein the measuring of the position of the UWB tag includes:
measuring the position by a TWR method of calculating an RTT from the plurality of access points, and converting the calculated RTT into a distance to the plurality of access points.

9. The precise positioning method using the UWB of claim 7, further comprising:
synchronizing the plurality of access points with each other based on the first scheduling period before the UWB position measurement starting signal is transmitted from the one or more access points; and
wherein the measuring of the position of the UWB tag includes:
measuring the position by a TDOA method of measuring an arrival time of the UWB position measurement starting signal received from the one or more access points.

10. A computer readable storage medium storing a computer program for executing the method according to claim 7.

11. A computer readable storage medium storing a computer program for executing the method according to claim 8.

12. A computer readable storage medium storing a computer program for executing the method according to claim 9.
